(19) United States
(12) Patent Application Publication
(10) Pub. No.: US 2010/0203298 A1
(43) Pub. Date: Aug. 12, 2010

(54) Two-ply board with interlocking truncated tetrahedrons for use as cardboard and construction panels

(76) Inventor: Eugene Garland Waddell, Charleston, SC (US)

Correspondence Address: Eugene G. Waddell, 107 Coming St., Charleston, SC, 29403, US

(21) Appl. No.: 12/378,063

(22) Filed: Feb. 11, 2009

(51) Int. Cl. B32B 3/12

(52) U.S. Cl. 428/178

(57) ABSTRACT

The product is a two-layered board that is stronger and less expensive than conventional panels made of three or more layers of such materials as cardboard, plastic, and metal. The product consists of two identical sheets of tetrahedrons arranged to face one another so as to interlock and buttress one another. The sheets can be formed by methods such as embossing and casting.

### BACKGROUND

1. Field of Invention

This invention relates to the type of cardboard that is used for shipping containers and that is usually corrugated and consists of three sheets of paper (Class 108), and it also relates to construction modules using tetrahedrons that ordinarily consist of struts or cells (Class 428/120).

2. Description of Prior Art

Corrugated cardboard is a type of paperboard that is the main product used for shipping containers, and it has been widely used for more than a century. It consists of a sheet of corrugated paper glued to one or more sheets of flat paper. The use of corrugated paper for packing was patented by A. L. Jones in 1871 (No. 122,023; A History of the Corrugated Shipping Container Industry in the United States by Wilbur F. Howell [Samuel M. Langston Co., Camden N.J.; 1940; page 13). The large scale production of corrugated carboard using opposing cylinders to form the corrugations was begun in 1875 at George A. Shyrock's mill in Chambersburg, Pa., and in the same year the firm of Thompson and Norris first manufactured boxes made from corrugated cardboard (History of Papermaking in the United States [1691-1969] by David C. Smith [Lockwood Publishing Co, New York; 1970; page 234]).

Numerous improvements had been made in the form, materials, and methods of manufacture for corrugated cardboard, and the present invention is intended to be created with a similar form (a multi-ply board), similar material (paper), and a similar method of manufacture (opposing cylinders). All of these aspects of the invention have long been in the public domain, and this patent makes no claims in regard how they might be applied to create a more rigid sheet of cardboard using two sheets of paper. The product being patented is for improvements in the structure of the product rather than for. materials or methods of manufacture.

Corrugated cardboard using only two sheets of paper (a corrugated sheet and a flat sheet) is not rigid. At least three sheets of paper are required to create a moderately rigid sheet of corrugated cardboard, and even the three-ply version it bends readily along the lines of the corrugation.

The tetrahedron has been selected as the basic element to maximize strength for boards of minimal thickness. The tetrahedron is the geometric solid with the smallest number of surfaces (four equilateral triangles), and it was known to be one of the primary solids by circa 400 B. C. (Plato, Timaeus 54d-55a). Of all geometric forms, the equilateral triangle and the tetrahedron have the most compressive strength. Alexander Graham Bell invented tetrahedral structures in 1902 (National Geographic, September 1988, p. 380). The unparalleled strength of the tetrahedron was widely publicized by Buckminster Fuller, who utilized it for his “Octet Truss” in 1961 to create flat roof structures and for other purposes (U.S. Pat. No. 2,986,241).

Many other patents have utilized the tetrahedron, and the most directly relevant is for “Tetrahedron Filled Panels” by Schaeffer et al. in 1993. Their patent covered a wide variety of uses of truncated tetrahedrons to create various types of boards (U.S. Pat. No. 5,266,379). One variant illustrated as their FIG. 8 was for a two-ply board consisting of tetrahedrons, but the tetrahedrons do not overlap or interlock. Their patent does not mention the possible application of the product for cardboard, and it has expired. The present patent is for improvements that enable the earlier patent by Shaeffer et al. to be put to practical use for the manufacture of a more rigid two-ply cardboard that will be stronger and cheaper than corrugated cardboard or to create equivalent products with the same structure for use in the construction industry such as cores for wallboard and roof slabs.

### OBJECTS AND ADVANTAGES

The objects and advantages of the present invention are:
(a) to create a more rigid cardboard than corrugated cardboard using less material;
(b) to increase the rigidity of cardboard by using overlapping tetrahedrons;
(c) to increase the rigidity of cardboard by using interlocking tetrahedrons;
(d) to reduce the cost of creating cardboard for shipping containers and other purposes;
(e) to reduce the amount of material expended to produce cardboard;
(f) to reduce the energy required to manufacture cardboard;
(g) to simplify the manufacturing process that is required to produce a three-ply product;
(h) to reduce the thickness of cardboard needed to adequately protect products during shipment and for other purposes;
(i) to reduce the cost of shipment by reducing the volume required to pack products safely in a more rigid container;
(j) to enable more rigid cardboard boxes to be stacked higher;
(k) to enable the strength of a two-ply cardboard of interlocking tetrahedrons to be increased still further if needed by adding a sheet of flat paper to one or both of its surfaces in order to encapsulate air within the truncated tetrahedrons;
(l) to enable the cost of cardboard to be reduced still further if only one sheet of truncated tetrahedrons affixed to one flat sheet of paper or another material would suffice;
(m) to enable the strength of a two-ply board of interlocking tetrahedrons to be increased still further if needed by incorporating two or more sets of the two-ply core to create one unit; and
(n) to enable the strength of a two-ply board with interlocking tetrahedrons to be increased still further if needed by using other types of materials regardless of how formed such as embossed plastic or sheet metal and cast iron, ceramic, or concrete for use in the construction industry or for equivalent purposes.

### DRAWING FIGURES

FIG. 1 shows how two sets of tetrahedrons have been arranged to interlock.

FIG. 2 shows how two identically formed sheets are offset so that their tetrahedrons will overlap and interlock.

### DESCRIPTION

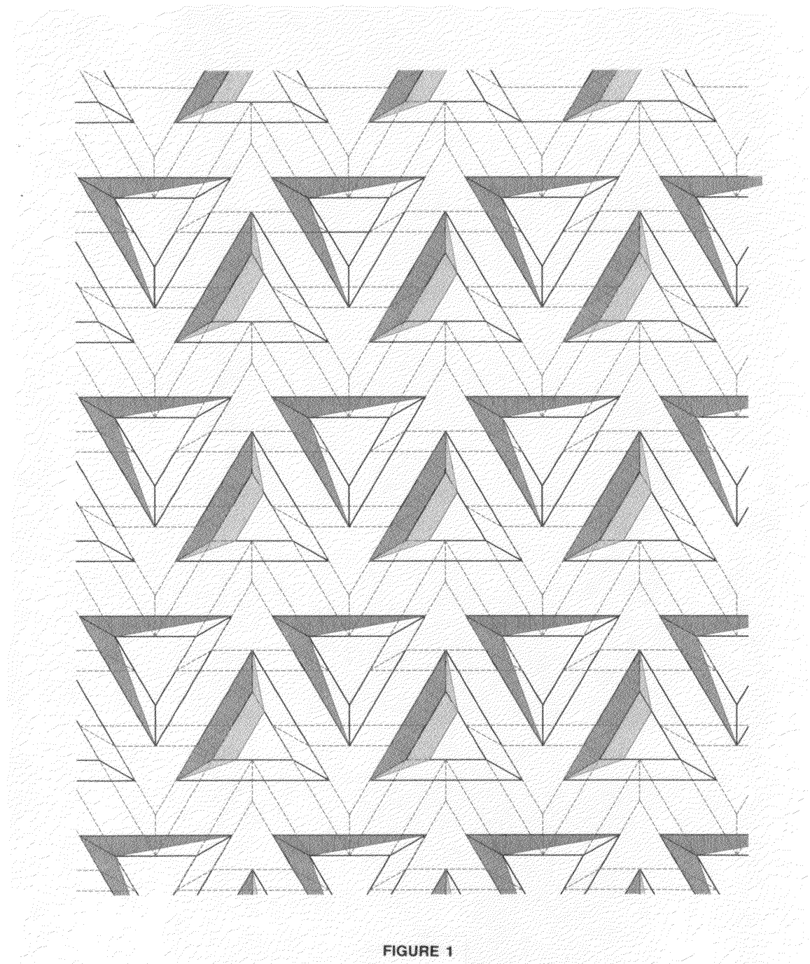

FIGS. 1: The solid lines in this drawing depict the upper surface of a two-ply sheet of cardboard, and the dotted lines depict the relationship of the lower sheet to the upper sheet. Both sheets of paper are identical. Each consists of paper with truncated tetrahedrons embossed into a flat page or formed during the manufacturing process for the paper. The tetrahedrons of the upper sheet face downward, and the tetrahedrons of the lower sheet face upward. The two sets of tetrahedrons have been aligned to overlap and interlock. The smaller triangles of the upper sheet are glued to the inside of the lower sheet, and the smaller triangles of the lower sheet are glued to the inside of the upper sheet. The larger and smaller triangles are equilateral triangles, and the sides of the truncated tetrahedrons also have angles of 60 degrees. Two corners of each tetrahedron are adjacent to the corners of two other tetrahedrons, and consequently these corners buttress one another. The upper and lower triangles are also wedged together in order to minimize lateral movement.

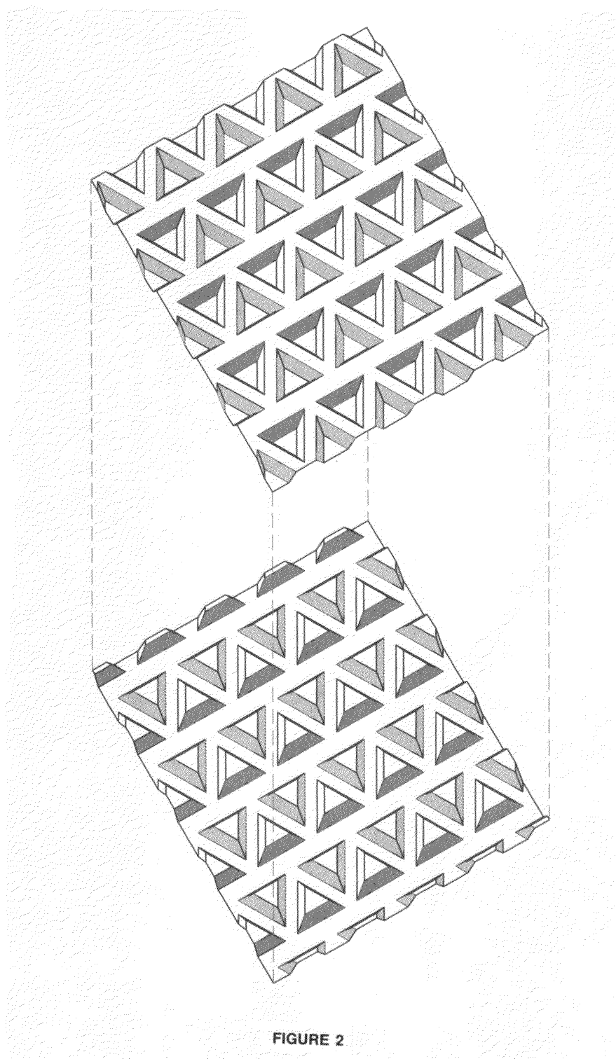

FIG. 2: These two sheets are identical except the upper sheet has truncated tetrahedrons that point downward, and the lower sheet has truncated tetrahedrons that point upward. The sheets have been offset so that when they are placed together, the upper and lower tetrahedrons will interlock as shown in FIG. 1.

1) A multi-layered plane comprising two sheets of paper or other material formed with truncated tetrahedrons in which the following new features have been added to a previous patent:
a. tetrahedrons that interlock by alternating in shape;
b. tetrahedrons that interlock by overlapping;
c. tetrahedrons placed adjacent to buttress one another;
d. tetrahedrons placed adjacent to wedge against one another.
